(19) United States
(12) Patent Application Publication
(10) Pub. No.: US 2004/0099971 A1
(43) Pub. Date: May 27, 2004

(54) Lens molds and method of using the same

(75) Inventors: Kai Su, Alpharetta, GA (US); Richard Lu, Alpharetta, GA (US); Debbie Makita, Suwanee, GA (US)

Correspondence Address: MERCHANT & GOULD PC, P.O. BOX 2903, MINNEAPOLIS, MN, 55402-0903, US

(73) Assignee: Technology Resource International Corporation

(21) Appl. No.: 10/303,216

(22) Filed: Nov. 25, 2002

(51) Int. Cl. B29D 11/00

(52) U.S. Cl. 264/1.32; 264/1.36; 264/1.38; 425/808; 425/412

(57) ABSTRACT

A method and apparatus for forming a lens using two molds that interconnect together so that their respective interior surfaces form the negative image of the lens to be cast therein. The molds are preferably made of plastic. A monomer fills the volume formed by the interior surfaces of the molds and is cured or polymerized to form a lens having desired dimensions and characteristics. It is noted that this abstract is provided to comply with the rules requiring an abstract that will allow a searcher or other reader to ascertain quickly the subject matter of the technical disclosure. The abstract is submitted with the understanding that it will not be used to interpret or limit the scope or meaning of the claims pursuant to 37 C.F.R. § 1.72(b).

### BACKGROUND OF THE INVENTION

1. Field of the Invention

The present invention encompasses a method and apparatus for lens casting, in which two molds, preferably formed of plastic, are interconnected or coupled together to form a mold cavity having substantially the same dimensions of the lens to be formed therein.

2. Background

The art of casting lenses involves introducing a lens-forming material, such as monomer, into a volume and then polymerizing the lens-forming material into a solid object. The formed lens can be used for ophthalmic or specialty optics applications.

Two mold pieces and a gasket typically form the volume that defines the dimensions of the lens to be cast. The prior art gaskets are known as “T-gaskets,” which include a bore having two ends that each complementarily receives a respective glass mold spaced apart a predetermined axial distance from the other mold. Different T-gaskets are required to form varying power lenses because they only allow one separation distance between molds. Accordingly, manufacturers must maintain separate T-gaskets for a +2 lens, another for a −3 lens, another for a −4 lens, etc.

An improvement of this “T-gasket” design is disclosed U.S. Pat. No. 6,103,148, in which at least one of the two molds is slidably movable along the bore of the gasket. This design thus has a “universal” gasket that can be used to form different powers of lenses, whereas a given T-gasket may be used to form one power of lens and a different T-gasket is used to form another power.

U.S. Pat. No. 5,551,663 teaches the use of plastic molds to function in a conventional gasket system. The disclosed molds are formed of plastic and are coated with a release-enhancing face that is not transferred to the formed lens; instead, the coating is designed to “protect the mold and also facilitate release of the lens or part after completion of the polymerization.” The purpose of this disclosed design, accordingly, is to allow the plastic molds to function exactly the same as conventional glass molds within a gasket system. However, the cost of the disclosed plastic molds is approximately equivalent to their glass counterparts, resulting in the lack of acceptance of this plastic design in the industry given their less sturdy construction.

### SUMMARY OF THE INVENTION

The present invention comprises a method and apparatus for casting a lens. A front mold and a rear mold, both of which are preferably formed of a plastic, interconnect to form a mold cavity that has substantially the same dimensions of the lens to be cast. That is, the front and rear together form a negative image of the lens to be formed.

The front mold has a lens-forming surface and an edge circumscribing the lens-forming surface. The rear mold similarly has a lens-forming surface and a protrusion circumscribing its lens-forming surface. The protrusion of the rear mold is of a size to complementarily receive at least a portion of the edge of the front mold therein. When the front and rear molds are coupled together, they collectively form the mold cavity between their respective lens-forming surfaces.

As one skilled in the art will appreciate, the design of this exemplary embodiment provides flexibility in casting lenses. As one consideration, the lens may be cast using two components—the front and rear molds—as opposed to three separate components—two molds and a gasket into which the molds are positioned.

The molds of the present invention may be designed to cast lenses of different strengths. That is, for a lens with given optical surfaces, the center lens thickness can be altered simply by manufacturing rear molds having a protrusion of different heights and selecting the correct rear mold to form the correct power lens. The front and rear molds may also be rotatably movable relative to each other to form the correct optical surfaces, which is useful if the surfaces are asymmetric relative to each other.

The plastic molds of the present invention also provide a labor and economic savings over use of a gasket with two molds. For example, with single-use life plastic molds, entire operations that lens-casting manufacturers now undertake using their glass counterparts and gaskets are eliminated, namely, cleaning and inspection. The start-up costs using the present invention are also lower than for an operation using glass molds and a gasket to cast lenses.

Plastic molds also may be manufactured more reproducibly than their glass counterparts. As such, lenses cast using the present invention may be formed to more exacting specifications.

### BRIEF DESCRIPTION OF THE FIGURES OF THE DRAWINGS

FIG. 1 is a plan view of the front and rear molds of the present invention coupled together.

FIG. 2A is a side cross-sectional view of FIG. 1, in which the mold cavity formed by the front and rear molds is of a dimension to cast a +2.00 D spectacle lens.

FIG. 2B is a side cross-sectional view of FIG. 1, in which the mold cavity formed by the front and rear molds is of a dimension to cast a −2.00 D spectacle lens.

FIG. 2C is a side cross-sectional view of FIG. 1, in which the mold cavity formed by the front and rear molds is of a dimension to cast a −6.00 D spectacle lens.

FIG. 3A is a side cross-sectional view of the front mold shown in FIGS. 1 and 2A.

FIG. 3B is a side cross-sectional view of the rear mold shown in FIGS. 1 and 2A.

FIG. 4 is a top view of FIG. 1.

FIG. 5 is a perspective view of the front and rear molds of FIG. 1 connected to a fill bag containing monomer.

### DETAILED DESCRIPTION OF THE INVENTION

The present invention is more particularly described in the following examples that are intended as illustrative only since numerous modifications and variations therein will be apparent to those skilled in the art. As used in the specification and in the claims, “a,” “an,” or “the” can mean one or more, depending upon the context in which it is used. The preferred embodiment is now described with reference to the figures, in which like numbers indicate like parts throughout the figures.

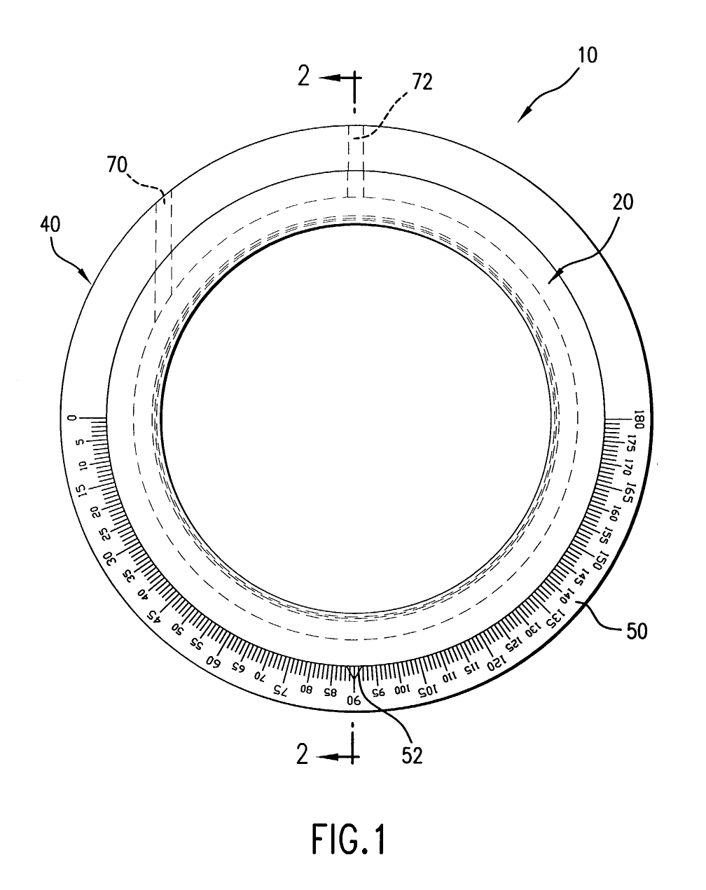

The present invention comprises a molding or casting device 10 and an associated method that may be used to form all powers and geometric shapes of lenses, such as spectacle lenses. Referring generally to FIGS. 1-5, the casting device 10 of the present invention includes a front mold 20 and a rear mold 40, both of which are preferably formed of a plastic. The front mold 20 has a lens-forming surface 22, an edge 28 circumscribing the lens-forming surface 22, and a base 30. The rear mold 40 likewise has a lens-forming surface 42 and a protrusion 46 circumscribing its lens-forming surface 42.

The protrusion 46 of the rear mold 40 is of a size to complementarily receive at least a portion of the edge 28 of the front mold 20 therein. It is desirable that when the protrusion 46 of the rear mold 40 interconnects with the edge 28 of the front mold 20, a substantially liquid-tight seal exists therebetween.

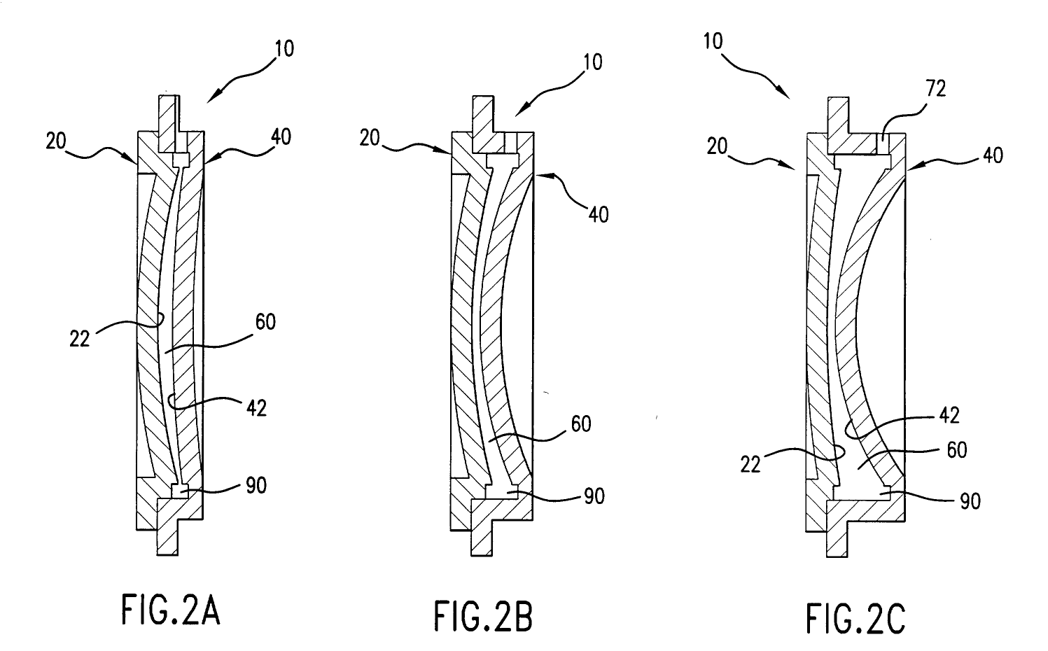

As shown in FIGS. 1-2C, the front and rear molds 20, 40 collectively form a mold cavity 60 between their respective lens-forming surfaces 22, 42 when the molds 20, 40 are joined, coupled, or combined together. In the preferred embodiment, the formed mold cavity 60 has dimensions of a desired lens formable therein; stated differently, the mold cavity 60 is a replica image of the lens to be formed by the front and rear molds 20, 40.

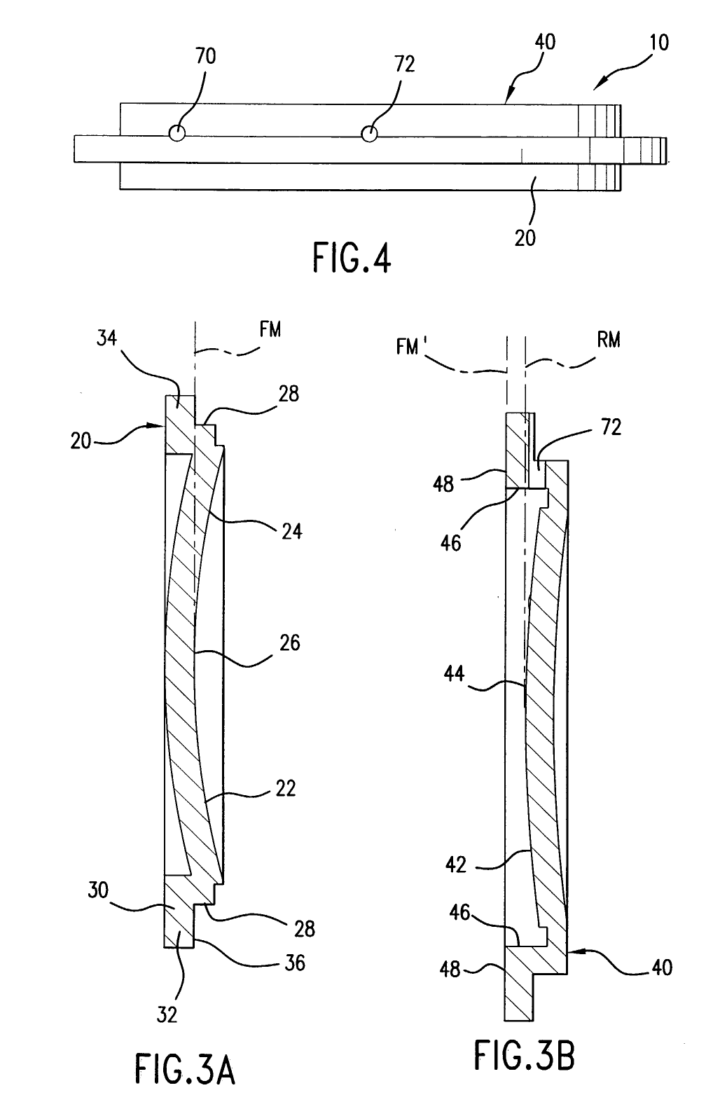

A key dimension of the formed mold cavity 60 is its center thickness. In the illustrated embodiment, a desired center thickness may be structurally attained as a result of the design of the molds 20, 40 and, moreover, the center thickness may be changed by coupling molds having different physical attributes together. Specifically, referring now to the embodiment shown in FIG. 3A, the base 30 of the front mold 20 has a perimeter 32 and further defines a flange 34 extending around its perimeter 32. The flange 34 preferably has a contacting surface 36 that is substantially planar. The lens-forming surface 22 of the front mold 20, in conjunction, has an internal surface 24 having a nadir 26 or low point, in which the nadir 26 tangentially intersects a plane FM defined by the contacting surface 36 of the flange 34. Accordingly, the nadir 26 of the lens-forming surface 22 and the contacting surface 36 of the flange 34 are at the same relative height when the front mold 20 is horizontally disposed.

Now referring to FIG. 3B, the protrusion 46 of the rear mold 40 includes an end surface 48 that is substantially planar. The lens-forming surface 42 of the rear mold 40 has an apex 44 so that a plane RM tangential to the apex 44 is substantially parallel to and spaced apart from a plane FM′ defined by the end surface 48. That is, when the rear mold 40 is horizontally disposed and supported by the end surface 48, the apex 44 is spaced above the end surface 48 a predetermined distance-that distance corresponding to the desired center thickness of the lens to be formed within the mold cavity 60.

Accordingly, when the end surface 48 of the protrusion 46 abuts the contacting surface 36 of flange 34 (i.e., when the front and rear molds 20, 40 are joined together as shown in FIGS. 2A-2C), the apex 44 and the nadir 26 of the respective lens-forming surfaces 22, 42 in the mold cavity 60 are spaced apart at the desired center thickness for the lens to be formed. Stated differently (but not explicitly shown in FIGS. 2A-2C), when the molds 20, 40 are coupled together, the plane RM tangential to the apex 44 is spaced apart from the plane FM′ defined by the end surface 48—which is co-planar with plane FM tangential to the nadir 26—at a distance substantially equivalent to the desired center thickness of the mold cavity 60. This design is one embodiment of a positioning means of the present invention.

It is also contemplated that the center thickness may be varied for a selected front and rear mold 20, 40 by further including a spacer ring (not shown) between the end surface 48 of the protrusion 46 and the contacting surface 36 of flange 34. The spacer ring has a fixed thickness, thereby increasing the center thickness of the mold cavity 60 by that thickness of the spacer ring. For example, a spacer ring having a thickness one millimeter in width disposed intermediate the end surface 48 and the contacting surface 36 would correspondingly result in the center thickness of the mold cavity 60—and lens to be formed therein—increasing by one millimeter. Such spacer rings, accordingly, reduce the number of molds that need to be manufactured to provide an operator a full library of components to cast all desired dimensions and strength of lenses.

In addition to center thickness, another relevant parameter in forming a desired lens is the geometric configuration or relationship of its two optical surfaces. When the two lens-forming surfaces 22, 42 are both spherical, the molds 20, 40 do not require any special rotational alignment relative to each other. This is because the respective surfaces have a constant radius along their different axes resulting in the surfaces being symmetric relative to each other.

For other lenses, however, the present invention includes a means for orienting the front and rear molds 20, 40 at a predetermined rotational position with respect to each other. In the illustrated embodiment, the front and rear molds 20, 40 are rotatably movable relative to each other so that the two molds may be positioned at one of a plurality of selected relative rotational orientations. This orienting means thus allows the operator to alter the dimensions or shape of the mold cavity 60 to desired values when either or both of the lens-forming surfaces 22, 42 of the front and rear molds 20, 40 have asymmetric curvature. Examples of asymmetrical lenses that operators may typically cast include the front surface of a lens being spherical with an add power-or less frequently being a piano surface—and, in conjunction or independently, the back surface being cylindrical or toric. A discussion of the features and types of such asymmetrical surfaces may be found in U.S. Pat. No. 6,103,148, which is incorporated herein in its entirety by reference.

Referring back to FIG. 1, the present invention also comprises an aligning means to allow the operator to appreciate the relative rotation of the two molds 20, 40 and position them accordingly. The aligning means shown in the illustrated embodiment comprises axis marks 50 on the rear mold 40 and an axis-positioning indicator 52 on the front mold 20. The axis marks 50 extend from 0° and 180° and are positioned in registry with the asymmetrical lens-forming surface. If injection molding or similar technique forms the rear mold 40, the markings are preferably etched into the die to ensure that an exact and permanent correspondence exists between the geometric characteristics of the lens-forming surface and the axis marks 50. The position indicator 52 of the front mold 20 is also preferably integrally formed by injection molding the components as a single unit. One skilled in the art will also appreciate that aligning means may alternatively comprise the axis marks being located on the front mold and an axis-positioning indicator on the rear mold. Other methods of visually indicating the rotational position of the molds relative to each other may also be used.

In preparing to cast the lens, the operator locates the position indicator 52 at a desired orientation relative to the axis marks 50 on the rear mold 40 either before the front and rear molds are joined together or afterwards (e.g., twisting the molds relative to each other once they are coupled together). The operator, thus, is able to position the two molds at a desired rotational location easily using the aligning means.

When the operator joins the two molds 20, 40 together after selecting them, it is preferred that a connecting means exists so that the components do not inadvertently separate during the lens casting process. Such a connecting means can take numerous forms known in the art, including the protrusion 46 and edge 28 having a tight frictional fit, the components respectively having a complementary detent and projection (not shown) that “snap” together when the molds are at the desired positions relative to each other (e.g., the center thickness is correct).

Other connecting means are also contemplated (not shown), including other designs in which the two molds 20, 40 snap into place or in which an external clip or containing device is used to hold the components at the correct axially-spaced position. The external connecting devices, such as a clip, are preferred when the spacer ring is used.

In still another contemplated embodiment, the front and rear molds are formed as a single unit so they are integrally joined to each other. This may occur during the forming process (i.e., during injection molding) so that the operator receives a preformed molding structure in which the front and rear molds are stationarily positioned relative to each other. This unitary design, however, has less flexibility than interchanging front and rear molds.

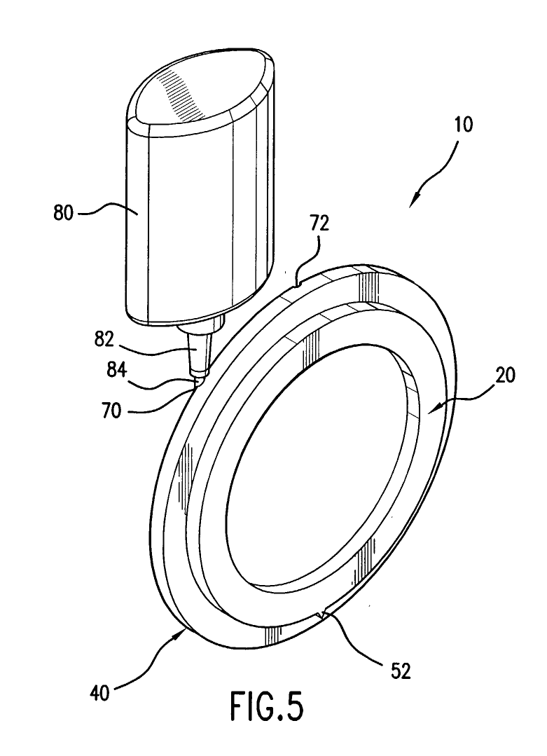

To form the lens once the front and rear molds 20, 40 are stationarily positioned together, a resin, such as a monomer or other lens-forming fluid, is added or injected into the mold cavity 60 and cured. To that end, the rear mold 40 defines a feed opening 70 through the protrusion 46, which is shown in FIGS. 1 and 4. It is preferred that the rear mold 40 also defines a vent opening 72 through the protrusion 46. The vent opening 72 provides fluid communication from the mold cavity 60 to outside of it (i.e., to ambient), which is shown in FIGS. 1-2C and 4. As best shown in FIGS. 1 and 4, when the front and rear molds 20, 40 are disposed upright, then the mold cavity 60 is substantially circular in plan view and the vent opening 72 is positioned at approximately the top center (the 12:00 o'clock position) and the feed opening 70 is offset from there approximately sixty degrees (the 10:00 o'clock position).

Referring now to FIG. 5, a fill bag 80 or the like containing a fluid such as monomer may be interconnected to the feed opening 70. More specifically, the fill bag 80 has an interior and an injection port 82 detachably connectable to the feed opening 70. When the injection port 82 is linked to the feed opening 70, the monomer located within the interior of the fill bag 80 may flow through the port into the mold cavity 60.

The injection port 82 and the feed opening 70 are preferably designed to complementarily engage each other. That is, the tip 84 of the injection port 82 is of a size to be complementarily received within the feed opening 70 to form a fluid-tight seal therebetween. More preferably, a means to detachably lock the tip 84 to the feed opening 70 is used so that separation between the two components is unlikely during transfer of monomer from the fill bag 80 into the mold cavity 60. Examples of the locking means (not shown) include the tip 84 of the injection port 82 being self tapping, the tip 84 and the feed opening 70 each having complementarily threaded surfaces that mate with each other, or other interlocking designs. In addition, the locking means preferably prevents the tip 84 of the injection port 82 from extending completely through the feed opening 70 and contacting either of the lens-forming surfaces 22, 42 of the respective molds 20, 40.

One consideration that a person skilled in the art takes into account in casting lenses is the flow characteristics of the monomer traversing from the fill bag 80 into the mold cavity 60. A primary concern is to avoid the introduction of air bubbles and ensure that any such bubbles escape out of the monomer before the curing begins; otherwise, the formed lens may be unacceptable if an air bubble discontinuity exists in the final product. In addressing this issue, the diameters of the tip 84 and feed opening 70 should be of a dimension and positioned to promote laminar flow when filling the mold cavity 60. Additionally, as best shown in FIG. 1, the fill opening 70 is oriented to direct the monomer along the side of the mold cavity during the initial filling, instead of free falling completely to the bottom. As noted above, the vent opening 72 is also preferably located at the top of the mold cavity 60 (i.e., at the 12:00 o'clock position) to vent air within the cavity 60 when displaced by the incoming monomer. The vent opening 72 being located at the top also allows any bubbles to escape before the curing process begins.

Another consideration regarding injecting monomer involves positioning the mold cavity 60 so that the add power (not shown) is oriented to have its flat top portion substantially upright or vertical during filling the mold cavity 60. This orientation assists in preventing air bubbles within the monomer from being trapped by this discontinuity in the lens-forming surface 22 of the front mold 20. Bubbles are more likely to remain in the mold cavity 60 if, for example, the flat top is horizontally oriented.

Referring again back to FIG. 5, the monomer bag 80 is at least partially constructed of a deformable surface on which the operator directs a compressive force so that one wall of the monomer bag 80 moves inwardly toward the opposed wall. When that compressive force is applied, the fluid monomer located within the interior is forced toward and out of the injection port 82 to enter the mold cavity 60 via the feed opening 70. In constructing a system necessitating a minimal capital investment, the illustrated embodiment of the present invention is designed so that the operator may hand squeeze the monomer bag 80 to fill the mold cavity 60.

Other means of injecting monomer into the mold cavity 60 are contemplated. Examples of such systems using a deformable bag to fill the mold cavity 60—particularly for more complex casting designs—is disclosed in U.S. patent application Ser. No. 10/095,130, filed on Mar. 11, 2002 and entitled “Method and Apparatus for Dispensing a Fluid,” which is incorporated herein by reference in its entirety. Monomer fill systems similar to the design disclosed in U.S. Pat. No. 6,103,148 is another option.

Once monomer fills the mold cavity 60, the monomer bag 80 is separated from the mold and then the monomer is cured (preferably with light as discussed in more detail below). As those skilled in the art appreciate, monomer shrinks approximately ten to fifteen percent by volume when it is cured. For some prior art designs in which the components forming the mold cavity 60 are stationarily positioned relative to each other (e.g., the T-gasket), this shrinkage creates internal stresses in the formed lens so that the cast lens sometimes requires annealing. The present invention is designed to reduce or eliminate such stresses by providing a reservoir volume in fluid communication with the mold cavity 60 to allow flow therebetween as the monomer volume shrinks.

Specifically, referring to FIGS. 2A-2C, the present invention preferably further comprises a fill channel 90 circumscribing the mold cavity 60 to act as the reservoir volume. The fill channel 90 is in fluid communication with both the vent opening 72 and the mold cavity 60. As will be noted, the illustrated fill channel 90 has a larger cross-sectional area than the adjacent portion of the mold cavity 60 formed by the lens-forming surfaces 22, 42 of the two molds 20, 40. When the monomer is being cured and correspondingly shrinks in volume, monomer from the fill channel 90 acts as a reservoir and is drawn into the mold cavity 60. Because the fill channel 90 is in fluid communication with ambient via the vent opening 72, this occurs without the stresses imparted in other systems that are sealed off from ambient.

One skilled in the art will also appreciate that monomer that exists in the fill channel 90 and is cured to become part of the lens subsequently may be easily broken off. One skilled in the art may further appreciate that although not necessary, it may be desirable to block the light adjacent the fill channel 90 so that the monomer held therein remains in a liquid form longer during the curing process. The larger relative cross-sectional area (and thus greater volume) of the fill channel 90 also results in maintaining the monomer in liquid form longer than in the mold cavity 60 during the curing process to assist further in reducing stresses.

As noted above, the molds 20, 40 of the present invention are preferably formed of a plastic material. Before discussing the advantages of using plastic molds and providing a few exemplary examples of suitable plastics that may be used with the present invention, it is important to note that one skilled in the art will appreciate that plastic is a broad term and very encompassing, namely, any of various synthetic or organic materials that can be molded or shaped, generally when heated, and then hardened into a desired form including, for example, polymers, resins, and cellulose derivatives.

When selecting the specific type of material to form the molds 20, 40, one skilled in the art will appreciate that to be useful in curing monomer, the selected plastic must transmit the curing radiation without melting, deforming, or stretching—at least until after the monomer is substantially cured or polymerized. Although thermal radiation is contemplated as a curing source and falls within the scope of the present invention, one skilled in the art will appreciate that the present invention may be better suited for photo curing. For photo curing of liquid resins, the desirable plastics include acrylic and methacrylic materials, an example of which is polymethylmethacrylate (PMMA). Some embodiments of available light transmissive PMMA are the OP1 and OP4 products by Cyro Industries, UV-T and V8-25 by Rohm & Haas, and CP75 from ICI. Other exemplary types of radiation transmissive plastics that may be used with the present invention include aliphatic polyesters, polyamides, polyurethanes, amorphous polyolefins, polycarbonates, polyimides and copolymers thereof. One skilled in the art will appreciate that these listed plastics are illustrative and the present invention is not limited to these examples.

Another factor that one skilled in the art considers in selecting the plastics to use is that they do not adversely interface or react with the material to be cured. If, for example, it is desired to use PMMA to form the molds 20, 40 based on its cost or physical properties, then compatible monomers include long chain or high molecular weight monomers or prepolymers that do not attack the mold 20, 40. Alternatively, the monomer desired to be used may be the primary consideration and the plastic forming the molds is chosen based on it being chemically resistant and non-reactive to that selected monomer.

Using plastic to form the molds 20, 40 of the present invention provides potential benefits over casting systems currently used in the industry. One consideration is that the plastics may be injection molded. There is extensive use and experience in the industry of injection molding PMMA and acrylics using ceramic or metal molds. To that end, the front and rear molds 20, 40 of the present invention may be formed, for example, by fabricating metal dies into which PMMA is injection molded in an assembly process having a high throughput. Each of the molds 20, 40 of the present invention, accordingly, will be formed to the same high tolerances to which the die is formed. Glass molds, in contrast, cannot be fabricated to such exacting standards, so the present invention can cast an ophthalmic lens that is formed to more rigorous criteria. One skilled in the art will further appreciate that the front and rear molds 20, 40 may be formed using other suitable high throughput methods used in the art for fabricating plastics, in contrast to glass molds that cannot feasibly be mass-produced to the requisite tolerances.

Another consideration with the front and rear molds 20, 40 is the economic comparison with conventional systems using two glass molds and a gasket. Although glass molds may be repeatedly used up to one hundred times or more, expenses accumulate that are associated with each casting, such as washing and drying that must ensure that the lens-forming surface is not contaminated. In fact, cleaning processes for glass molds are typically laborious, time-consuming and inefficient, involving manual scraping and soaking in noxious solvents. Furthermore, the glass molds must be inspected after each use and cleaning to insure suitability for another lens-making cycle. Plus, many times the glass molds are inadvertently chipped and/or broken before their potential useful life is reached. An associated problem is the occurrence of lens yield loss resulting from unwitting reuse of damaged lens molds, in which the operator sometimes does not discover that a glass mold is damaged until after a casting process has been completed.

In comparison, when the plastic molds 20, 40 of the present invention are mass-produced, their cost is expected to be lower than for glass molds-which cannot feasibly be produced in bulk. Part of the reason is that plastics such as PMMA are relatively inexpensive. And, since PMMA and many other plastics are easy to cut or break after curing, removal of the polymerized lens from the molds once used is potentially quicker and easier than separating expensive glass molds, which must be delicately handled to attempt to ensure that their entire useful life is reached. Hence, the cost associated with using glass molds is believed to be more expensive over time than the use of plastic molds of the present invention, even single-use plastic molds.

The economic considerations of the present invention also include the lower initial investment that a retailer must outlay before starting operations. That is, the initial start-up cost of using mass-produced plastic molds of the present invention is notably lower than for glass molds used in gasket systems because it is expensive to acquire and maintain the large inventory of glass molds needed for a lens molding operation. Likewise, in one embodiment of the present invention, assembly and fill machine(s) would be eliminated as hand assembly and filling are viable manufacturing methods. It is, accordingly, financially easier for new retailers to enter the market of casting ophthalmic lenses using the present invention.

Another aspect of the present invention involves coating the lens-forming surfaces 22, 42 of the front and rear molds 20, 40 with an abrasion-resistant composition that is transferred to the lens when cured. More specifically, the lens-forming surfaces 22, 42 are preferably covered with a composition that transfers in situ to the optical surfaces of the cast lens as a protective coating on the final product. Without such a hardcoating on the lens that prevents or resists abrasion, scratching, and marring, the optical quality of the cast spectacles may more easily degrade from haze and poor image quality.

One example of such an abrasion-resistant coating is disclosed in U.S. Pat. No. 5,049,321, which is incorporated herein by reference in its entirety. This patent discloses that the coating composition consists substantially of reactants having at least triacrylate functionality, a photoinitiator, and a polymerization inhibitor reactive with oxygen. After applying such a coating composition in the form of an ultraviolet curable liquid to the mold, the coating is subjected to ultraviolet radiation in an oxygen-containing environment such that the coating composition is cured to a hard/abrasion-resistant state. Then, when casting and curing the ophthalmic lens, the monomer is permitted to harden and react with acrylate groups at the coating/lens interface so that the coated lens is removed from the mold with the abrasion-resistant coating adhering thereto as an integral part of the surface of the optical surfaces of the lens. Other similar techniques of forming an abrasion-resistant coating on a cast lens are disclosed in U.S. Pat. Nos. 4,338,269 and 4,758,448, both of which are also incorporated herein by reference in their entireties.

One skilled in the art will appreciate that although not necessary, using such an abrasion-resistant coating on the lens-forming surfaces 22, 42 produces a final product that consumers may prefer and that also allows the operator to separate more easily the front and rear molds 20, 40 from the lens cast therebetween. To that end, the abrasion-resistant coating may be applied to the lens-forming surfaces 22, 42 of the front and rear molds 20, 40 using a process the same as or similar to that disclosed in U.S. patent application Ser. No. 10/075,637, filed on Feb. 12, 2002 and entitled “Methods of Applying a Coating to an Optical Surface,” which is incorporated herein by reference in its entirety. Alternative treatment methods of the molds 20, 40 known in the art include spraying, dipping, brushing, flow coating, spin coating, and the like.

The present invention also encompasses a method of casting a lens using the molds 20, 40 of the present invention. Of note, this process occurs without a gasket, which is typically employed in currently-used technologies. Stated differently, the present invention allows casting lenses with two components—the front and rear molds 20, 40 coupled together—instead of three components as required in other designs—two molds and a gasket.

For an initial step, the method of the present invention involves providing front and rear molds 20, 40. As indicated above, although it is contemplated that the components are prejoined, the front and rear molds 20, 40 are preferably combined or coupled together to form the mold cavity 60 by the operator. When the operator receives the prescription of a spectacle lens, he or she selects the front and rear molds 20, 40 that, together, form a mold cavity 60 having the dimensions of the lens desired to be formed. To that end, the front and rear molds 20, 40 are movable between a stored position and a molding position. In the stored position, the molds 20, 40 are separated from each other by, for example, being stored in designated areas or bins with molds having similar characteristics. In the molding position, the protrusion 46 of the rear mold 40 receives the edge 28 of the front mold 20 to form the mold cavity 60 after the operator retrieves the correct molds from the designated storage areas.

It is contemplated using computer or other system (not shown) to assist the operator in selecting the correct molds 20, 40 when preparing to cast a lens. As one example, the present invention contemplates that the operator enters the parameters of the lens to be formed (e.g., the prescription including add power) into a computer or the like. Algorithms in an associated computer program determine the appropriate front and rear molds 20, 40 to be used to form the desired lens and then provide an output indicating this information. As one optional variation, this embodiment may additionally illuminate a light at the storage stations above the specific location where the appropriate molds 20, 40 are stored. The indicating lights assist the operator in locating the appropriate molds to reduce the chance of the operator inadvertently picking an incorrect mold to make the lens. Yet another option is to use a bar code or other tracking system (not shown) on the outer surfaces of the molds 20, 40 that the system scans to verify that the two proper molds are being used.

After the operator locates the front and rear molds 20, 40 and is ready to reposition them from the stored to the molding position, the output of the optional computer system may further assist the operator by indicating additional positioning and aligning information. As discussed above, in the illustrated embodiment the front mold 20 is rotatably movable relative to the rear mold 40 so that the two molds 20, 40 are at one of a plurality of selected rotational orientations relative to each other. The computer may provide an output indicating the orientation of the two molds 20, 40 relative to each other when the lens-forming surfaces 22, 42 of the respective molds have asymmetric curvature. For the illustrated embodiment, the computer preferably indicates the appropriate location of the axis-positioning indicator 52 on the front mold 20 relative to the axis marks 50 on the rear mold 40.

As to the positioning of the molds 20, 40 to obtain the correct center thickness for the mold cavity 60, this parameter is preferably considered in selecting the rear mold 40, as different rear molds have protrusions of varying lengths in the illustrated embodiment that proportionally alter the center thickness of the mold cavity 60. In an alternative embodiment discussed above, the computer may be programmed to indicate that a specific spacer ring be included between the front and rear molds 20, 40 to obtain the appropriate center thickness.

However, one skilled in the art will appreciate that other means besides a computer system may be used to determine the correct mold to use with the present invention. As one skilled in the art will further appreciate, however, the present invention utilizing the computer system allows an operator with minimal training and understanding of the principles of lens casting to manufacture successfully lenses when a customer provides a prescription.

After the front and rear molds 20, 40 are joined to form the mold cavity 60 of the desired dimensions and stationarily positioned relative to each other, the operator connects the monomer bag 80 to the feed opening 70. The operator then injects the monomer into the mold cavity 60, which may occur by hand squeezing the monomer bag 80 in the illustrated embodiment.

During filling, the monomer enters via the feed opening 70 while the vent opening 72 allows displaced air to exit the mold cavity 60 to ambient. The filling method used with the present invention minimizes the quantity of monomer wasted and decreases the chances of air bubbles being formed within the lens. The monomer bag 80 may contain a quantity of monomer that is sufficient to form only a single lens or, alternatively, for multiple castings.

Because monomer is a viscous fluid, it will inherently fill the mold cavity 60 at a controlled rate. By design, the fill rate may be further controlled by reducing the diameter of the feed opening 70 and tip 84 of the monomer bag 80. Since the front and rear molds 20, 40 are formed of plastic, they can be clear or transparent so that the operator may visually observe the monomer entering and filling the mold cavity 60. When the cavity 60 is filled with monomer (as well as the optional fill channel 90) so that the monomer reaches the vent opening 72, the monomer bag 80 is removed from the front and rear molds 20, 40. If necessary, the feed opening 70 is plugged, which may simply involve spot curing the monomer at that location to plug it or using a covering that snaps into the feed opening 70. The vent opening 72, however, preferably remains in communication with ambient during curing.

The monomer within the mold cavity 60 is then cured to form the lens after ensuring that no bubbles are present. The preferred method involves curing using photo curing, although other curing methods are contemplated in conjunction with or alternatively to light. One primary advantage of photo curing, such as UV radiation, is that the plastic molds 20, 40 do not reach a temperature at which they may melt, deform, or stretch, which is more likely to occur with thermal radiation curing. UV curing methodologies are taught, for example, in U.S. Pat. Nos. 4,919,850; 5,524,419; 5,804,107; 5,981,618; 6,103,148; and 6,241,505, all of which are incorporated herein by reference in their entireties.

After the monomer is cured to harden, then the operator removes the cured lens from within the mold cavity 60. Because the preferred molds 20, 40 are formed of plastic, such as relatively inexpensive PMMA, it is contemplated in the presently preferred embodiment that the molds will have a one-use life. That is, the molds can be disposable so that there are no problems if the molds are chipped or broken during the removal of the lens from the mold cavity 60. In fact, breaking the molds may assist in separating the cured lens from the mold cavity 60, and the molds are more brittle than the cured lens so the lens does not also break. One skilled in the art will also appreciate that treating the lens-forming surfaces 22, 42 with abrasion-resistant coatings, such as the composition disclosed in U.S. Pat. No. 5,049,321, will assist in separating the lens from the mold as well as providing the lens with a protective scratch-resistant barrier. One skilled in the art will further appreciate that the plastic molds of the present invention can be used for more than one casting before their useful life ends.

Although the present invention has been described with reference to specific details of certain embodiments thereof, it is not intended that such details should be regarded as limitations upon the scope of the invention except as and to the extent that they are included in the accompanying claims.

What is claimed is:

1. A casting device, comprising:
a. a front mold formed of a plastic and having a lens-forming surface, an edge circumscribing the lens-forming surface, and a base; and
b. a rear mold formed of a plastic and having a lens-forming surface and a protrusion circumscribing the lens-forming surface, wherein the protrusion is of a size to complementarily receive at least a portion of the edge of the front mold therein so as to form a mold cavity between the lens-forming surfaces of the front and rear molds, the mold cavity having dimensions of a desired lens formable therein, the rear mold defining a feed opening through the protrusion that is in fluid communication with the mold cavity.

2. The casting device of claim 1, further comprising a vent opening defined through the protrusion of the rear mold, wherein the vent opening is in fluid communication with the mold cavity.

3. The casting device of claim 2, wherein, when the front and rear molds are disposed upright, the mold cavity is substantially circular in plan view, the vent opening is positioned at substantially the top center, and the feed opening is offset approximately sixty degrees therefrom.

4. The casting device of claim 1, wherein the base of the front mold has a perimeter and further defines a flange extending around at least a portion of the perimeter, wherein the flange has a contacting surface that is substantially planar.

5. The casting device of claim 4, wherein the lens-forming surface of the front mold has a concave internal surface having a nadir, wherein the nadir tangentially intersects a plane defined by the contacting surface of the flange.

6. The casting device of claim 5, wherein the protrusion of the rear mold has an end surface that is substantially planar,
wherein the lens-forming surface of the rear mold has an apex so that a plane tangential to the apex is substantially parallel to and spaced apart from a plane defined by the end surface, and
wherein, when the end surface of the protrusion abuts the contacting surface of flange, the apex and the nadir of the respective lens-forming surfaces in the formed mold cavity are spaced apart at a desired center thickness for the mold cavity.

7. The casting device of claim 6, wherein the plane tangential to the apex is spaced apart from the plane defined by the end surface at a distance substantially equivalent to the desired center thickness of the mold cavity.

8. The casting device of claim 1, wherein the front mold is rotatable relative to the rear mold so that the two molds are at one of a plurality of selected rotational orientations relative to each other so as to alter characteristics of the mold cavity when the lens-forming surfaces of the respective front and rear molds have asymmetric curvature.

9. The casting device of claim 8, further comprising means for aligning the front and rear molds at a predetermined rotational orientation relative to each other.

10. The casting device of claim 9, wherein the aligning means comprises axis marks on the rear mold and an axis-positioning indicator on the front mold.

11. The casting device of claim 1, wherein the front and rear molds are movable between a stored position, in which the molds are spaced apart from each other, and a molding position, in which the protrusion of the rear mold receives the edge of the front mold to form the mold cavity.

12. The casting device of claim 11, wherein, when in the stored position, the rear mold is selected from a group of rear molds, in which for one selected front mold, different rear molds form mold cavities having different dimensions when in the molding position.

13. The casting device of claim 12, wherein the mold cavity has a center thickness and wherein different rear molds have protrusions of varying lengths so that the center thickness of the mold cavity formed in the molding position vary proportionally to the length of the protrusion.

14. The casting device of claim 13 wherein, when in the molding position, the front mold is rotatably movable relative to the rear mold so that the two molds are at one of a plurality of selected rotational orientations relative to each other so as to alter characteristics of the mold cavity when the lens-forming surfaces of the respective front and rear molds have asymmetric curvature relative to each other.

15. The casting device of claim 1, further comprising a fill channel circumscribing at least a portion of the mold cavity and in fluid communication with the mold cavity.

16. The casting device of claim 15, wherein the fill channel has a larger cross-sectional area than the mold cavity adjacent thereto.

17. The casting device of claim 1, further comprising a fill bag having an interior and an injection port detachably connectable to the feed opening, wherein when the port is connected to the feed opening, a fluid located within the interior of the fill bag may traverse through the injection port and into the mold cavity.

18. The casting device of claim 1, further comprising monomer disposed within the mold cavity.

19. The casting device of claim 1, wherein the plastic forming the front and rear molds comprises polymethylmethacrylate.

20. The casting device of claim 1, wherein the lens-forming surfaces of the front and rear molds are coated with a composition that transfers in situ to a lens when formed within the mold cavity.

21. A casting device, comprising:
a. a front mold formed of a plastic and having a substantially concave lens-forming surface, an edge circumscribing the lens-forming surface, and a base;
b. a rear mold formed of a plastic and having a lens-forming surface and a protrusion circumscribing the lens-forming surface, wherein the protrusion is of a size to complementarily receive at least a portion of the edge of the front mold therein so as to form a mold cavity between the lens-forming surfaces of the front and rear molds, the mold cavity having dimensions of a desired spectacle lens formable therein; and
c. means for injecting a fluid into the mold cavity.

22. The casting device of claim 21, wherein the injecting means comprises:
a. a feed opening defined through the protrusion of the rear mold and in fluid communication with the mold cavity; and
b. a vent opening defined through the protrusion of the rear mold, wherein the vent opening is in fluid communication with the mold cavity and ambient to allow fluid flow therethrough.

23. The casting device of claim 22, wherein, when the front and rear molds are disposed upright, the mold cavity is substantially circular in plan view, the vent opening is positioned at substantially the top center, and the feed opening is offset approximately sixty degrees therefrom.

24. The casting device of claim 21, further comprising means for positioning the front and rear molds at a predetermined axial separation distance to obtain a desired center thickness within the mold cavity.

25. The casting device of claim 21, further comprising means for aligning the front and rear molds at a predetermined rotational orientation relative to each other.

26. The casting device of claim 22, further comprising:
a. a fill bag having an interior; and
b. means for detachably connecting the feedbag to the feed opening for allowing a fluid located within the interior of the fill bag to traverse into the mold cavity.

27. The casting device of claim 21, further comprising means for orienting the front and rear molds at a predetermined rotational position with respect to each other.

28. The casting device of claim 21, wherein the plastic forming the front and rear molds comprises polymethylmethacrylate.

29. The casting device of claim 21, wherein the lens-forming surfaces of the front and rear molds are coated with a composition that transfers in situ to a lens when formed within the mold cavity.

30. The casting device of claim 21, wherein the injecting means injects monomer into the mold cavity.

31. The casting device of claim 21, further comprising a fill channel circumscribing at least a portion of the mold cavity and in fluid communication with the mold cavity.

32. A casting component, comprising:
a casting mold formed of a plastic, the mold having a lens-forming surface and a border circumscribing the lens-forming surface,
wherein the border of the lens-forming surface is sized to complementary couple with a corresponding portion of another mold to form a fluid-tight seal therebetween,
wherein, when the casting mold is coupled to the other mold, the interior surface of the casting mold defines a portion of a mold cavity, in which the mold cavity has dimensions to form a desired lens therein, and
wherein the mold cavity communicates with ambient to allow injection of a mold forming fluid to fill the mold cavity from external of the mold cavity.

33. A method of casting a lens, comprising:
a. coupling a front mold and a rear mold together to form a mold cavity therebetween having dimensions of a desired lens formable therein, the front and rear molds interconnecting around the periphery of the mold cavity and forming a substantially fluid-tight seal in that connection therebetween;
b. injecting a lens-forming fluid into the mold cavity and simultaneously venting displaced fluid from the mold cavity to ambient;
c. curing the lens-forming fluid within the mold cavity to form a lens having dimensions substantially the same as mold cavity; and
d. separating the cured lens from the front and rear molds.

34. The method of claim 33, wherein the front and rear molds are formed of a plastic.

35. The method of claim 34, wherein the plastic is polymethylmethacrylate.

36. The method of claim 33, wherein the lens is cast without using a gasket interconnecting the front and rear molds.

37. The method of claim 33, wherein the lens-forming fluid is monomer.

38. The method of claim 33, wherein photo curing is used to harden the lens-forming fluid.

39. The method of claim 33, wherein the front and rear molds are rotatably movable relative to each other to one of a plurality of rotational orientations.

40. The method of claim 39, wherein the front and rear molds include markings, to indicate their rotational orientation relative to each other.

41. The method of claim 33, wherein the front and rear molds have dimensions so that when coupled together, the mold cavity has a desired center thickness.

42. The method of claim 41, wherein the front and rear molds are selected from a plurality of molds that collectively form the desired center thickness when coupled together.

43. The method of claim 33, wherein before coupling the front and rear molds together, substantially all of the surfaces of the front and rear molds that define the mold cavity are coated with a composition that transfers in situ to the lens formed within the mold cavity.

44. The method of claim 33, wherein the formed lens is a spectacle lens.
